(19) United States
(12) Patent Application Publication
(10) Pub. No.: US 2001/0029492 A1
(43) Pub. Date: Oct. 11, 2001

(54) Electronic transaction method and apparatus

(75) Inventor: Tatsuya Uchikata, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/813,960

(22) Filed: Mar. 22, 2001

(30) Foreign Application Priority Data
Mar. 23, 2000 (JP) 2000-081332
Jan. 12, 2001 (JP) 2001-004904

(51) Int. Cl. H04K 1/00; H04L 9/00; G06F 17/60

(52) U.S. Cl. 705/64

(57) ABSTRACT

First identifier is assigned to transaction information sent from a buyer's terminal and is sent back to the buyer's terminal. A second identifier associated with the first identifier and a part of the transaction information are sent to a vendor's terminal. An instruction indicating that goods to be sold in the transaction, to which the second identifier is attached, have been delivered to a retail store is sent to the buyer's terminal. Upon receiving the first identifier and the second identifier, a check is made to see if there is a correspondence between them. If there is a correspondence, an instruction is output to allow the delivered goods be passed to the buyer.

### FIELD OF THE INVENTION

The Present invention relates to a method for conducting an electronic transaction over a communication network and an apparatus used for the method.

### BACKGROUND OF THE INVENTION

As the Internet becomes more popular, more transactions are conducted via web pages. With the advent of this innovative transaction system, not only large companies but also individuals may sell goods easily.

### SUMMARY OF THE DISCLOSURE

However, making a transaction involves a number of cumbersome tasks. Such tasks include the notification of the vendor's account number to the buyer, paying money into the vendor's account, notification of buyer's address to the vendor, shipping of the goods from the vendor to the buyer, and the like. Also, a trouble frequently occurs in which the goods are not delivered even after the buyer has paid for them.

It is a first object of the present invention to provide a transaction method and a transaction apparatus that allow transactions to be made easily and securely.

It is a second object of the present invention to provide a transaction method and a transaction apparatus that prevent illegal conducts.

### DEFINITION

The term “goods” used herein denotes one or more articles of commerce, collectively, which embraces all the items which can be an object of the transaction.

According to a first aspect of the present invention, there is provided a transaction method comprising the steps of:

(a) assigning a first identifier to transaction information sent from a buyer's terminal, the transaction information relating to a transaction;

(b) sending the first identifier to the buyer's terminal and sending a second identifier associated with the first identifier and a part of the transaction information to a vendor's terminal;

(c) sending a notification to the buyer's terminal in response to an instruction indicating that goods, to which the second identifier is attached, have been delivered to a retail store, the goods being obtained by referencing the part of the transaction information and being sold in the transaction;

(d) checking to see if there is a correspondence between the identifiers upon receiving the first identifier received by a buyer and the second identifier attached to the delivered goods;

(e) outputting an instruction allowing the delivered goods to be passed to the buyer if there is the correspondence; and

(f) sending an instruction requesting to transfer an amount for the goods from a buyer's account to a predetermined account.

The invention according to the first aspect makes the transaction easy and secure, allows a third-party organization (information management company) to monitor the transactions to prevent illegal actions, integrates personal information management, and protects personal information. In addition, the use of a retail store that is open around the clock eliminates time constraints.

According to a second aspect, at least one of sending the first identifier, sending the second identifier, sending the part of the transaction information, and sending the notification is done via electronic mail.

The second aspect allows desired information to be sent via electronic mail, ensuring convenience.

According to a third aspect, there is provided a transaction apparatus comprising:

(a) means for assigning a first identifier, termed as “first identifier”, to transaction information sent from a buyer's terminal, the transaction information relating to a transaction;

(b) means for sending the first identifier to the buyer's terminal and for sending a second identifier associated with the first identifier and a part of the transaction information to a vendor's terminal;

(c) means for sending a notification to the buyer's terminal in response to an instruction indicating that goods, to which the second identifier is attached, have been delivered to a retail store, the goods being obtained by referencing the part of the transaction information and being sold in the transaction;

(d) means for checking to see if there is a correspondence between the first identifiers upon receiving the identifier received by a buyer and the second identifier attached to the delivered goods;

(e) means for outputting an instruction allowing the delivered goods to be passed to the buyer if there is the correspondence; and

(f) means for sending an instruction requesting to transfer an amount for the goods from a predetermined account to a vendor's account.

The third aspect also makes the transaction easy and secure, allows a third-party organization (information management company) to monitor the transactions to prevent illegal actions, integrates personal information management, and protects personal information. In addition, the use of a retail store that is open around the clock eliminates time constraints.

According to a fourth aspect, the means for sending an instruction requesting to transfer the amount for the goods to a vendor's account sends an instruction to request to transfer the amount for the goods from an account of a retail store specified by the buyer to the vendor's account.

The fourth aspect allows the buyer to pay and accept the goods at a specified retail store.

According to a fifth aspect, the means for sending an instruction requesting to transfer the amount for the goods to a vendor's account sends an instruction to request to transfer the amount for the goods from an account of a delivery service provider to the vendor's account, the delivery service provider delivering the goods.

The fifth aspect allows the delivery service provider to deliver the goods directly to the buyer and receive payment there.

According to a sixth aspect, there is provided a transaction method comprising the steps of:

(a) assigning a first identifier to transaction information sent from a buyer's terminal, the transaction information relating to a transaction;

(b) sending the first identifier to the buyer's terminal and sending a second identifier associated with the first identifier and a part of the transaction information to a vendor's terminal;

(c) attaching, by a vendor, the second identifier to goods which is obtained by referencing the part of the transaction information and which will be sold in the transaction;

(d) passing the goods, via a retail store or directly, to a delivery service provider;

(e) searching for, by the delivery service provider, a retail store specified by a buyer and delivering the goods to the retail store;

(f) sending a notification to the buyer's terminal in response to the second identifier entered from a terminal at the retail store, the second identifier being attached to the goods;

(g) checking to see if there is a correspondence between the first identifier recorded on a recording medium taken by a buyer and the second identifier attached to the delivered goods;

(h) passing the delivered goods to the buyer if there is the correspondence; and

(i) transferring an amount for the delivered goods from a buyer's account to a vendor's account.

According to a seventh aspect, there is provided a transaction method comprising the steps of:

(a) assigning a first identifier to transaction information sent from a buyer's terminal, the transaction information relating to a transaction;

(b) sending the first identifier to the buyer's terminal and sending a second identifier associated with the first identifier and a part of the transaction information to a vendor's terminal;

(c) attaching, by a vendor, the second identifier to goods which is obtained by referencing the part of the transaction information and which will be sold in the transaction;

(d) passing the goods, via a retail store or directly, to a delivery service provider;

(e) searching for, by the delivery service provider, a buyer and delivering the goods to a buyer; and

(f) checking to see if there is a correspondence between the first identifier held by the buyer and the second identifier attached to the delivered goods and, if there is the correspondence, passing the delivered goods to the buyer, and giving an instruction, via a portable terminal, to transfer an amount for the delivered goods from a delivery service provider's account to a vendor's account.

The invention according to the 6th or 7th aspect allows the transaction to be completed with the identifier and the second identifier, also makes the transaction easy and secure, allows a third-party organization (information management company) to monitor the transactions to prevent illegal actions, integrates personal information management, and protects personal information. In addition, the use of a retail store that is open around the clock eliminates time constraints.

According to an eighth aspect, a transaction method comprises the steps of:

(a) assigning a first identifier to transaction information sent from a buyer's terminal, the transaction information relating to a transaction;

(b) sending the first identifier to the buyer's terminal;

(c) sending a second identifier associated with the first identifier and a part of the transaction information to a vendor's terminal;

(d) sending a notification to the buyer's terminal in response to an instruction indicating that goods, to which the second identifier is attached, have been delivered to a retail store, the goods being obtained by referencing the part of the transaction information and being sold in the transaction;

(e) accepting the first identifier received by a buyer and the second identifier attached to the delivered goods and checking to see if there is a correspondence between the first and second identifiers; and

(f) outputting an instruction allowing the delivered goods to be passed to the buyer if there is the correspondence.

According to a ninth aspect, a transaction apparatus comprises:

(a) means for assigning a first identifier to transaction information sent from a buyer's terminal, the transaction information relating to a transaction;

(b) means for sending the first identifier to the buyer's terminal;

(c) means for sending a second identifier associated with the first identifier and a part of the transaction information to a vendor's terminal;

(d) means for sending a notification to the buyer's terminal in response to an instruction indicating that goods, to which the second identifier is attached, have been delivered to a retail store, the goods being obtained by referencing the part of the transaction information and being sold in the transaction;

(e) means for accepting the first identifier received by a buyer and the second identifier attached to the delivered goods and checking to see if there is a correspondence between the first and second identifiers; and

(f) means for outputting an instruction allowing the delivered goods to be passed to the buyer if there is the correspondence.

According to a tenth aspect, a transaction method comprises the steps of:

(a) assigning a first identifier to transaction information sent from a buyer's terminal, the transaction information relating to a transaction;

(b) sending the first identifier to the buyer's terminal;

(c) sending a second identifier associated with the first identifier and a part of the transaction information to a vendor's terminal;

(d) attaching, by a vendor, the second identifier to goods which is obtained by referencing the part of the transaction information and which will be sold in the transaction;

(e) passing the goods, via a retail store or directly, to a delivery service provider;

(f) searching for, by the delivery service provider, a retail store specified by a buyer and delivering the goods to the retail store;

(g) sending a notification to the buyer's terminal in response to the second identifier entered from a terminal at the retail store, the second identifier being attached to the goods;

(h) checking to see if there is a correspondence between the first identifier recorded on a recording medium taken by a buyer and the second identifier attached to the delivered goods; and

(i) passing the delivered goods to the buyer if there is the correspondence.

According to an eleventh aspect, a transaction method comprises the steps of:

(a) assigning a first identifier to transaction information sent from a buyer's terminal, the transaction information relating to a transaction;

(b) sending the first identifier to the buyer's terminal;

(c) sending a second identifier associated with the first identifier and a part of the transaction information to a vendor's terminal;

(d) attaching, by a vendor, the second identifier to goods which is obtained by referencing the part of the transaction information and which will be sold in the transaction;

(e) passing the goods, via a retail store or directly, to a delivery service provider; and

(f) searching for, by the delivery service provider, a buyer and delivering the goods to the buyer.

According to the 8th to 11th aspects the transaction can be completed with the first identifier and the second identifier, also makes the transaction easy and secure, allowing a third-party organization (information management company) to monitor the transactions to prevent illegal actions, integrates personal information management, and protects personal information. In addition, the use of a retail store that is open around the clock eliminates time constraints.

According to a twelfth aspect, the transaction method of the aspect 1, 2, 6-8, 10, or 11, further comprises the steps of:

(i) receiving the first identifier, a name of goods to be returned, and a reason for returning the goods from the buyer's terminal to send the name of the goods to be returned and the reason for returning the goods to the vendor's terminal when the buyer requests to return the goods during a cooling-off period after the transaction is completed and before the buyer pays for the goods;

(k) extending the cooling-off period;

(l) sending a notification to the vendor's terminal in response to an instruction indicating that the goods to be returned has been delivered to a vendor-specified retail store, the first identifier being attached by the buyer to the goods to be returned;

(m) accepting the second identifier received by the vendor and the first identifier attached to the goods to be returned to check to see if there is a correspondence between the identifiers; and

(n) outputting an instruction allowing the delivered goods, which will be returned, to be gassed to the vendor if there is the correspondence.

According to the 12th aspect, the goods information is added to the information corresponding to the transaction ID to determine the cause of the trouble that may occur. In addition, information to the buyers about the vendors to which many buyers return goods as well as information to the vendors on the customers who return goods for unaccountable reasons help prevent troubles.

According to a 13th aspect, the transaction method of the aspect 1, 2, 6-8, 10, or 11, further comprises the step of preventing the information from being searched for using the identifier or the second identifier when the transaction is completed.

According to the 13th aspect, it prevents identifiers from being searched for after completion of payment, thereby preventing personal information on buyers from being made public on the network.

According to a 14th aspect, in the transaction method of the aspect 8, 10, or 11, the step of sending the first identifier to the buyer's terminal comprises also sending an instruction to pay the amount for the goods into the predetermined account, and wherein the step of sending the second identifier and the part of the transaction information to the vendor's terminal receives a payment completion notification from a banking terminal at a predetermined bank in which the amount for the goods has been paid into the predetermined account under a name of the first identifier to send the payment completion notification, the second identifier, and the part of the transaction information to the vendor's terminal.

The 14th aspect avoids the troubles that the goods are not delivered or the goods must be returned.

According to a 15th aspect, in the transaction method of the aspect 1, 2, 6-8, or 10-14, the first identifier received by the buyer or the second identifier received by the vendor is a printed identifier of the first identifier or the second identifier displayed on the buyer's terminal or the vendor's terminal.

The 15th aspect eliminates the need for recording or storing the first identifier, making the transaction easy and secure.

According to a 16th aspect, in the transaction method of the aspect 1, 2, 6-8, or 10-15, the first identifier and/or the second identifier is a bar code.

The 16th aspect makes the first identifier or the second identifier easy to read, thus making the transaction easy and quick.

Further aspects of the present invention relate to the programs for performing the methods by means of a computer system or a computer-aided network system e.g., Internet.

The processing procedure for the transaction method and the transaction apparatus may be programmed and recorded on a recording medium for execution by the CPU. The media for recording the procedure include semiconductor recording media such as a ROM or an IC card, optical recording media such as a CD-ROM or a DVDROM, and magnetic recording media such as a floppy disk or a hard disk.

Further aspects of the invention are disclosed in the appended claims, the entire disclosure thereof being incorporated herein by reference thereto.

### BRIEF DESCRIPTION OF THE DRAWINGS

FIG. 1 is a schematic block diagram showing a system including a transaction apparatus used in a first embodiment of the present invention.

FIG. 2 is a schematic diagram showing the contents of an account table 100 in the transaction apparatus in the first embodiment of the present invention.

FIG. 3 is a schematic diagram showing the contents of a buyer table 110, a retail store table 120, and a transaction management table 130 in the transaction apparatus in the first embodiment of the present invention.

FIG. 4 is a schematic block diagram showing a system including a transaction apparatus used in a second embodiment of the present invention.

FIG. 5 is a schematic block diagram showing a system including a transaction apparatus used in a third embodiment of the present invention.

FIG. 6 is a schematic block diagram showing a system including a transaction apparatus used in a fourth embodiment of the present invention.

### PREFERRED EMBODIMENTS OF THE INVENTION

Some embodiments of the present invention will now be described more in detail with reference to the drawings.

(First embodiment)

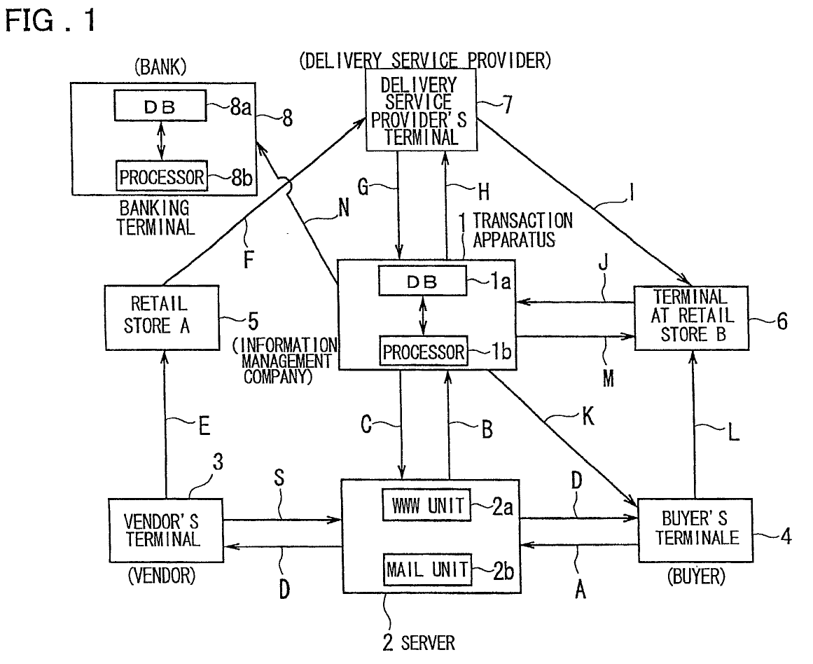

FIG. 1 is a schematic block diagram showing a system including a transaction apparatus in a first embodiment of the present invention. The transaction system comprises a transaction apparatus 1, a server 2, a vendor's terminal 3, a buyer's terminal 4, a retail store A 5, a retail store B 6, a delivery service provider's terminal 7, and a banking terminal 8. The terminals are connected to send and receive required information.

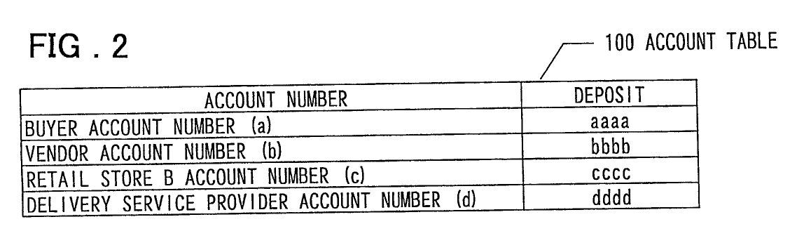

The server 2 comprises a WWW unit 2a for displaying a site screen and a mail unit 2b for sending mail. The server 2 may be located anywhere on the network as long as it is accessible. The banking terminal 8 comprises a database 8a and a processor 8b that processes account transfer and so on. As shown in FIG. 2, the database 8a contains an account table 100. The account table 100 contains information on the correspondence between account numbers and deposit amounts. In the example shown in FIG. 2, a buyer's account number “a”. a vendor's account number “b”, a retail store B's account number “c”, and a delivery service provider's account number “d”, as well as the corresponding deposit amounts, “aaaa”, “bbbb”, “cccc”, and “dddd”, are stored.

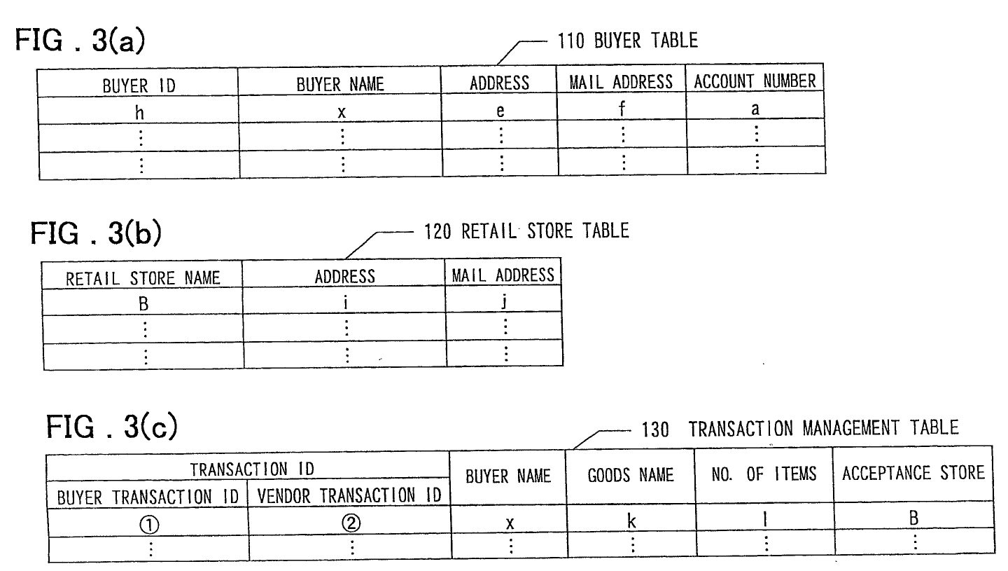

The transaction apparatus 1, a major component of the present invention, comprises a database 1a and a processor 1b that processes various types of processing and sends mail. As shown in FIGS. 3(a) - 3(c), the database 1a contains a buyer table 110, a retail store table 120, and a transaction management table 130.

The buyer table 110 contains information on the correspondence between a buyer's name and his or her information such as an address, a mail address, an account number, and a buyer ID (hereinafter, an ID means an identifier). In the example shown in FIG. 3(a), the table contains information on the correspondence among the buyer ID “h”, buyer name “x”, address “e”, mail address “f”, and account number “a ” . The retail store table 120 contains information on the correspondence among a retail store name, address, and mail address (as necessary). In the example shown in FIG. 3(b), the table contains information on the correspondence among the retail store name “B”, address “i”, and mail address “j”.

The transaction management table 130 contains information on the correspondence among a buyer transaction ID, a vendor transaction ID, a buyer ID, the name of goods, the number of goods items to be purchased, and a goods-acceptance store i. e., a store at which the buyer desires to receive the goods. They are stored in the table each associated with the transaction ID (see FIG. 3(c)).

Note that the buyer transaction ID, which is assigned to a buyer for each transaction, is different from a buyer ID that is only one ID assigned to each buyer. Also, note that the vendor transaction ID, which is assigned to a vendor for each transaction, is different from a vendor ID that is only one ID assigned to each vendor. In addition, a transaction ID is the identifier of a transaction that is assigned by the processor 1b to each transaction.

In the example shown in FIG. 3(c) the buyer “x” purchases “I” pieces of goods “k” and accepts the goods at the store “B”. For this transaction, the processor 1b associates the buyer transaction ID “\mathring{1}” with the vendor transaction ID “\mathring{2}” and stores this information in the storage area of the transaction ID in the table.

In the transaction management table 130 shown in FIG. 3(c), the buyer and the vendor are identified by the vendor ID and the buyer ID. This means that the personal name and the address of the buyer “x” are not stored in this table. Private information on individuals is stored only in the table shown in FIG. 3(a). The information in the table in FIG. 3(a) is protected most carefully.

The information stored in the tables shown in FIG. 3 is not limited to the information described above. Other information may be added as necessary. Also, the transaction ID may be generated based on the buyer ID, the vendor ID, the name of goods “k”, the number of goods items “I”, and the goods-acceptance store “B”. The buyer transaction ID “\mathring{1}” and the vendor transaction ID “\mathring{2}” may be associated with the transaction ID. Moreover, the buyer transaction ID “\mathring{1}” and/or vendor transaction ID “\mathring{2}” may be used as the transaction ID.

Assuming that the information shown in FIG. 2 and FIGS. 3(a) and 3(b) is stored in the tables, buyer X and vendor Y conduct a transaction. As indicated by the reference code S in FIG. 1, vendor Y uses the vendor's terminal 3, as necessary, to change information provided by the WWW unit 2a to manage the site.

When buyer X browses through information supplied by the WWW unit 2a and decides to buy desired goods, he or she uses the buyer's terminal 4 to enter information. Buyer X enters and sends transaction information composed of the buyer ID “h”, the name of the desired goods “k”, the number of goods items “I”, and the goods-acceptance store “B” (step A). Then, the entered transaction information is sent to the processor 1b of the transaction apparatus 1 via the server 2 (step B).

The processor 1b assigns a buyer transaction ID “\mathring{1}” to this transaction information and stores the ID in the buyer transaction ID storage area in the transaction management table 130. Then, the processor 1b stores a vendor transaction ID “\mathring{2}”, which is associated with the buyer transaction ID “\mathring{1}”, in the vendor transaction ID storage area. After these IDs are stored, the transaction management table 130 is as shown in FIG. 3(c). The processor 1b requests the mail unit 2b to send the buyer transaction ID “\mathring{1}” to the buyer's terminal 4 via electronic mail (step C) and, at the same time, to send the vendor transaction ID “\mathring{2}” to the vendor's terminal 3 via electronic mail (step D). The electronic mail sent to the vendor's terminal 3 also includes the goods name “k” and the number of goods items “I”. Buyer X records the buyer transaction ID “\mathring{1}” on recording medium such as memory or paper (The ID may be printed or hand-written. When the transaction is done over a cellular phone, the received buyer transact ion ID may be stored in the memory of the phone. That is, any means or method for use in identification at a retail store where the buyer is to accept the goods may be used). On the other hand, vendor Y packs “I” pieces of goods, identified by the name “k”, and attaches the vendor transaction ID “\mathring{2}” on the pack with a seal.

Vendor Y takes this packed goods (on which the vendor transaction ID “\mathring{2}” is attached) to a nearest retail store A 5 (step E). The retail store A 5 passes this goods to a delivery service provider (step F). The delivery service provider enters the ID “\mathring{2}” attached on the goods from the delivery service provider's terminal 7 to send it to the processor 1b (step G). In response to this, the processor 1b references the transaction management table 130 to get the name of the goods acceptance store name “B” corresponding to the ID “\mathring{2}”. The processor 1b also references the retail store table 120 to search for the address “i” of the store “B” and sends the retail store name and its address to the delivery service provider's terminal 7 (step H) . The delivery service provider delivers the goods to the retail store at this address (step I).

When a goods arrival message and the ID are received from a terminal 6 at retail store B (step J) the processor 1b references the transaction management table 130 to search for the buyer “X” corresponding to the ID. In addition, the processor 1b references the buyer table 110 to search for the address and sends mail to the mail address “f” of the buyer “X” to notify the buyer of the arrival of the goods (step K).

Upon receiving this notification, buyer X goes to retail store B with a recording medium, such as a piece of paper, on which the previously-received ID is printed (step L). The ID attached on the goods and the ID recorded on the recording medium taken by buyer X are entered from the terminal 6 at retail store B. The processor 1b checks the correspondence between these two IDs (step M). The processor 1b references the transaction ID storage area in the transaction management table 130. If the processor 1b finds that there is a correspondence between them, it sends a message to the terminal 6 at retail store B to notify that there is a correspondence. Then, the buyer may accept the goods.

Moreover, the processor 1b references the transaction management table 130 to find the buyer “X” corresponding to the buyer transaction ID. At the same time, the processor 1b references the buyer table 110 to search for the account number “a” of the buyer “X”. The processor 1b also searches for the account number “b” (not shown) of vendor Y pre-stored in the database 1a and sends an instruction to the banking terminal 8 to request it to transfer the amount of the purchased goods from the account number “a” to the account number “b” (step N). For example, the processor 1b stores the amount, obtained by multiplying the unit price of the goods by the number of purchased goods items, in a predetermined area and requests the banking terminal 8 to transfer the amount.

The processor 8b of the banking terminal 8 transfers the amount of the purchased goods from the account number “a” of the bank account (buyer account) to the account number “b” of the bank account of the vendor to complete a sequence of transact ion steps. In this embodiment, a transaction is completed by using a buyer transaction ID and a vendor transaction ID. This method makes the transaction easy and secure, allows a third-party organization (information management company) to monitor the transactions to prevent illegal actions, integrates personal information management, and protects personal information. In addition, the use of a retail store that is open around the clock eliminates time constraints. The use of electronic mail in sending the IDs and a part of transaction information and in notifying goods arrival ensures convenience.

Various modifications and variations of the embodiment are possible without departing from the spirit of the present invention. For example, the mail unit 2b of the server 2 may send mail to notify the arrival of the goods, or a password may be created for the buyer to browse the site.

(Second embodiment)

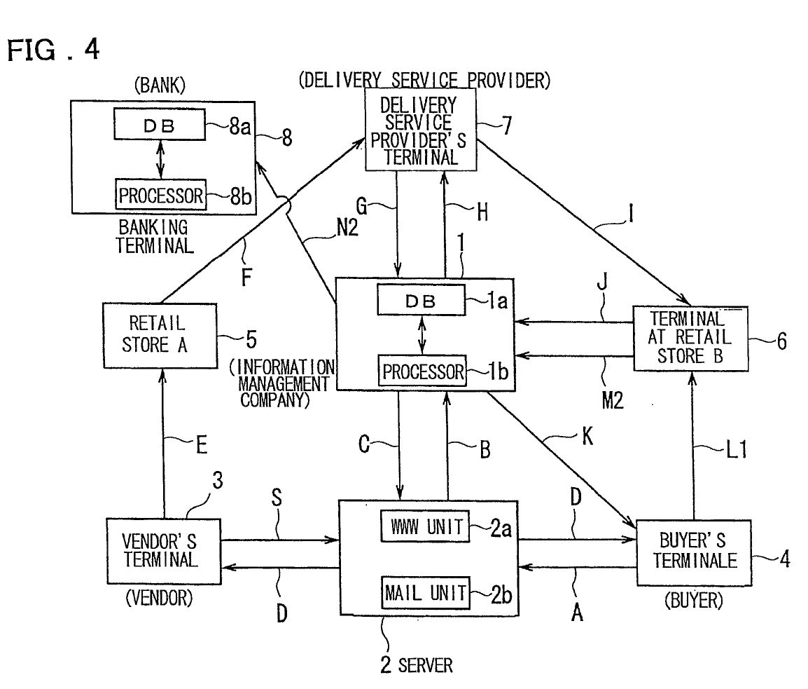

FIG. 4 is a schematic block diagram showing a system including a transaction apparatus used in a second embodiment of the present invention. This embodiment is similar to the first embodiment except that buyer X pays for the goods at the retail store B 6 when he or she accepts the goods there. As shown by the reference code L1, buyer X goes to the retail store B and pays for the goods there. In this case, payment information is sent from the terminal 6 at the retail store B to the processor 1b. The processor 1b issues an instruction requesting that the amount of the purchased goods be transferred from the bank account of the retail store B to the bank account of vendor Y (step N2). In response to this instruction, the processor 8b transfers the amount of the purchased goods from the account number “c” of the bank account (account of retail store B) to the account number “b” of the bank account of the vendor to complete a sequence of transaction steps.

Therefore, in this embodiment, information that the goods have been accepted is sent to the banking terminal 8 via the transaction apparatus 1. And, the banking terminal 8 transfers the amount of the purchased goods from the bank account of retail store B to the bank account of vendor Y. This method saves labor.

(Third embodiment)

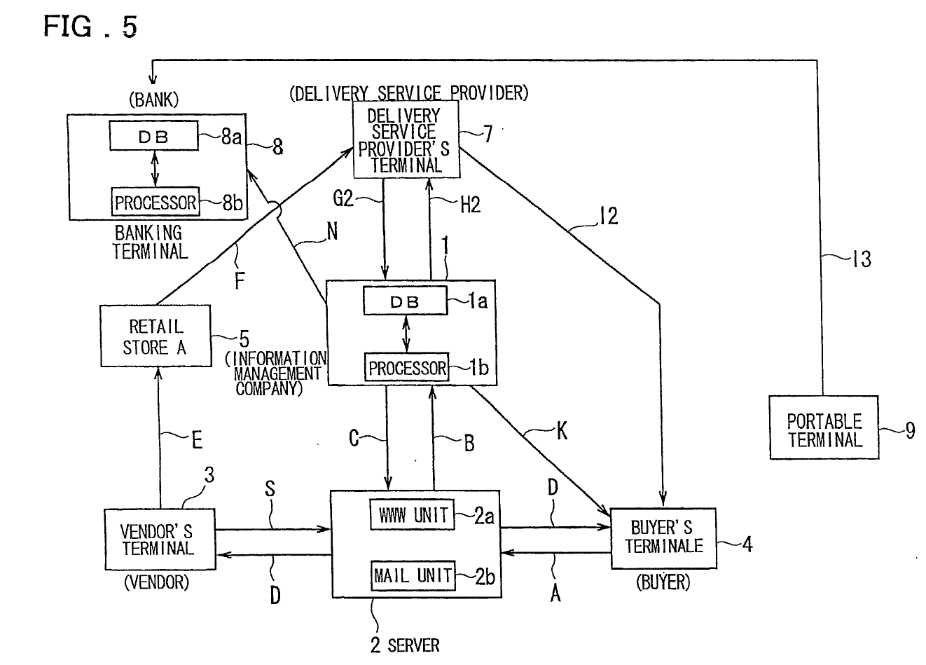

FIG. 5 is a schematic block diagram showing a system including a transaction apparatus used in a third embodiment of the present invention. This embodiment is similar to the first embodiment except that a delivery service provider delivers goods, not via retail store B, but directly to a buyer 4 and receives payment there. When ID information is entered from a delivery service provider's terminal 7 (step H2), a processor 1b references a transaction management table 130 to search for buyer X and, at the same time, references a buyer table 110 to obtain the address of buyer X (step G2). The delivery service provider delivers the goods directly to the buyer and receives payment.

In this embodiment, the goods are delivered directly to the buyer's home and, therefore, the buyer need not pass the buyer transaction ID as the certificate of the buyer. Instead, some type of certificate indicating that the goods have been accepted, such as a signature or an electronic acknowledgment, is necessary.

At this time, the delivery service provider uses a p portable terminal 9 to give an instruction requesting that the amount of the purchased goods be transferred from the bank account of the delivery service provider to the bank account of the vendor Y (step 13). In response to this instruction, a processor 8b transfers the amount of the purchased goods from the account number “d” of the bank account (account of delivery service provider) to the account number “b” of the bank account of the vendor to complete a sequence of transaction steps.

Therefore, in this embodiment, information that the goods have been accepted is sent from the portable terminal 9 of the delivery service provider to the banking terminal 8. The amount of the purchased goods is transferred from the bank account of the delivery service provider to the bank account of the vendor. This method saves buyer's (X) labor. In addition, the method reduces the delivery time because the goods are delivered, not via retail store B, but directly to the buyer.

(Fourth embodiment)

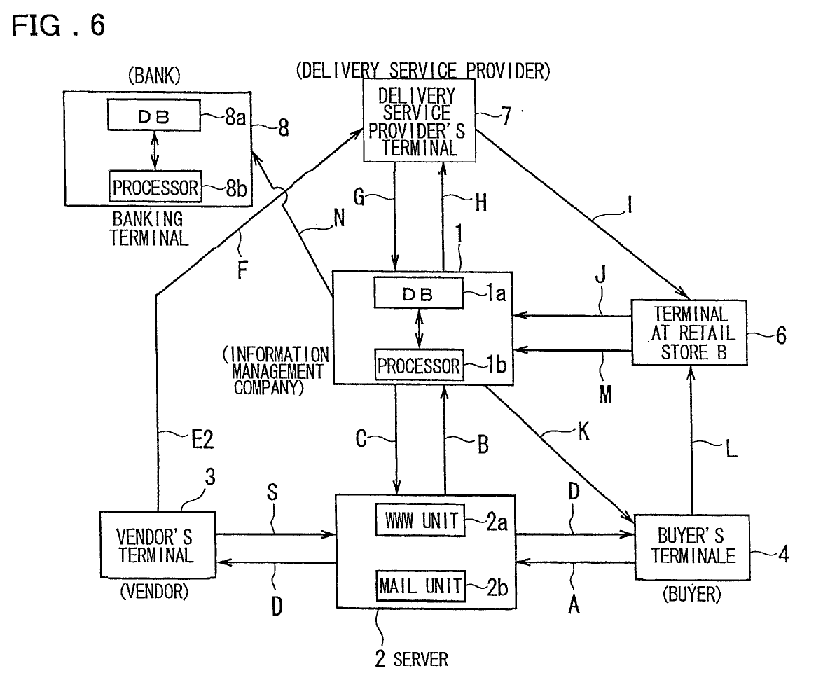

FIG. 6 is a schematic block diagram showing a system including a transaction apparatus used in a fourth embodiment of the present invention. This embodiment is similar to the first embodiment except that the delivery service provider goes to the vendor to get goods. This embodiment is suitable when there is a large number of goods items because the delivery service provider goes to the vendor to get the goods.

(Fifth embodiment)

Next, how goods are returned will be described. There is a cooling-off period “a” after a transaction is completed and before the transaction apparatus sends a payment instruction to the bank. If the buyer is not satisfied with the goods and wants to return them (for example, the goods are not like those shown on the WWW page), the buyer sends the buyer ID and a reason for returning the goods to the transaction apparatus. The transaction apparatus sends the received goods name and the reason to the vendor and extends the cooling-off period (for example, the period is extended to “b” ). During the cooling-off period “b”, the buyer takes the goods, with the buyer transaction ID attached, to a convenience store or a delivery service provider to return them to the vendor. The goods-return procedure is the reverse of the goods-delivery procedure. The transaction apparatus searches for the vendor ID using the buyer transaction ID, and searches for the address of the vendor using the vendor ID.

To avoid troubles, the vendor must describe the goods information correctly on the WWW on which the page is posted. Adding goods information to the information corresponding to the transaction ID determines the cause of the trouble that may occur In addition, information to the buyers about the vendors to which many buyers return goods as swell as information to the vendors on the customers who return goods for unaccountable reasons help prevent troubles.

(Sixth embodiment)

Next, the effective period of a vendor transaction ID or a buyer transaction ID will be described. This period, if provided prevents the transaction apparatus from searching for information using a vendor transaction ID or using a buyer transaction ID after a transaction is completed. The advantage is that personal information is managed integrally and therefore personal information is protected.

(Seventh embodiment)

Next, another payment method will be described. At the same time the buyer receives a buyer transaction ID from the transaction apparatus before the completion of a transaction, he or she also receives an instruct ion requesting that the amount of the purchased goods be paid into a predetermined account. In response to this instruction, the buyer pays the amount through the bank under the buyer transaction ID. The bank confirms that the amount has been paid and then sends a payment completion message from the banking terminal to the transaction apparatus. In response to this payment completion message, the transaction apparatus sends a payment completion notification, the vendor transaction ID, and a part of the transaction information to the vendor's terminal. Upon receiving the vendor transaction ID and so on, the vendor attaches the vendor transaction ID to the goods and passes the goods to the retail store or the delivery service provider. The steps that follow are the same as those of other embodiments.

In this embodiment, if the bank temporarily keeps the amount paid by the buyer until the transaction is completed or if the bank transfers the amount to the vendor a few days after the completion of the transaction, the troubles that the goods are not delivered or the goods must be returned may be avoided.

(Eighth embodiment)

Next, a buyer transaction ID will be described. A buyer transaction ID may not only be sent to a buyer via mail but be displayed on an application screen of a web page. The buyer prints the display (e.g., a bar code) to get the buyer transaction ID. In particular, a bar code displayed as a buyer transaction ID makes it easy to identify the correspondence between vendor transaction IDs and buyer transaction IDs, for example, when goods are accepted. A bar code displayed as a vendor transaction ID has the same effect.

(Ninth embodiment)

When a transaction (for example, an Internet auction) is successfully completed on the network, the vendor “a” receives information on the buyer “b” (e.g., name, address, ID, etc.) via electronic mail. Then, from a web page on the WWW (for example, delivery service provider or retail store), the vendor enters information on the vendor “a” (ID acceptable), information on the buyer “b”, and information on the goods to register them with the transaction apparatus. The transaction apparatus assigns a transaction ID to the information and sends this transaction ID to the vendor “a”. The vendor “a” prints the received transaction ID, attaches it to the goods, and passes the goods to a convenience store or a delivery service provider. The delivery service provider accesses the transaction apparatus to search for the address of the buyer based on the transaction ID attached on the received goods, carries the goods to the address identified by the search, receives the amount for the goods from the buyer, and passes the received amount to the vendor via some means. The transaction described above allows a part of processing performed by a computer to be conducted manually.

As described above, in the embodiments of the present invention, identifiers are assigned to transaction information for integral management. This method makes the transaction easy and secure, allows a third-party organization (information management company) to monitor the transactions to prevent illegal actions, integrates personal information management, and protects personal information. In addition, transferring the amount of purchased goods after the acceptance of the goods is confirmed allows both the vendor and the buyer to sell and buy goods securely. Another advantage is the acceptance of goods at a retail store. This allows a buyer to accept goods any time. Especially, the use of a retail store that is open around the clock eliminates time constraints.

The terminals used in each embodiment may have precreated programs installed on recording media such as a hard disk (HD) for execution by the central processing unit (CPU).

The embodiments of the present invention have been described. As described above, various modifications and variations of the embodiments are possible without departing from the spirit of the present invention.

The meritorious effects of the present invention are summarized as follows.

According to the present invention, a transaction may be completed by using an identifier and a second identifier. Therefore, the transaction may be conducted easily and securely.

A third-party organization (information management company) may monitor the transactions to prevent illegal actions.

Personal information management is integrated and personal information is protected.

The use of a retail store that is open around the clock eliminates time constraints.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A transaction method comprising the steps of:
(a) assigning a first identifier to transaction information sent from a buyer's terminal, the transaction information relating to a transaction;
(b) sending the first identifier to said buyer's terminal and sending a second identifier associated with the first identifier and a part of the transaction information to a vendor's terminal;
(c) sending a notification to said buyer's terminal in response to an instruction indicating that goods, to which the second identifier is attached, have been delivered to a retail store, the goods being obtained by referencing the part of the transaction information and being sold in the transaction;
(d) checking to see if there is a correspondence between the identifiers upon receiving the first identifier received by a buyer and the second identifier attached to the delivered goods;
(e) outputting an instruction allowing the delivered goods to be passed to the buyer if there is the correspondence; and
(f) sending an instruction requesting to transfer an amount for the goods from a buyer's account to a predetermined account.

2. The transaction method as defined by claim 1 wherein at least one of sending the first identifier, sending the second identifier, sending the part of the transaction information, and sending the notification is done via electronic mail.

3. A transaction apparatus comprising:
(a) means for assigning a first identifier, termed as “first identifier”, to transaction information sent from a buyer's terminal, the transaction information relating to a transaction;
(b) means for sending the first identifier to said buyer's terminal and for sending a second identifier associated with the first identifier and a part of the transaction information to a vendor's terminal;
(c) means for sending a notification to said buyer's terminal in response to an instruction indicating that goods, to which the second identifier is attached, have been delivered to a retail store, the goods being obtained by referencing the part of the transaction information and being sold in the transaction;
(d) means for checking to see if there is a correspondence between the first identifiers upon receiving the identifier received by a buyer and the second identifier attached to the delivered goods;
(e) means for outputting an instruction allowing the delivered goods to be passed to the buyer if there is the correspondence; and
(f) means for sending an instruction requesting to transfer an amount for the goods from a predetermined account to a vendor's account.

4. The transaction apparatus as defined by claim 3 wherein said means for sending an instruction requesting to transfer the amount for the goods to the vendor's account sends an instruction to request to transfer the amount for goods from an account of a retail store specified by the buyer to the vendor's account.

5. The transaction apparatus as defined by claim 3 wherein said means for sending an instruction requesting to transfer the amount for the goods to the vendor's account sends an instruction to request to transfer the amount for the goods from an account of a delivery service provider to the vendor's account, the delivery service provider delivering the goods.

6. A transaction method comprising the steps of:
(a) assigning a first identifier to transaction information sent from a buyer's terminal, the transaction information relating to a transaction;
(b) sending the first identifier to said buyer's terminal and sending a second identifier associated with the first identifier and a part of the transaction information to a vendor's terminal;
(c) attaching, by a vendor, the second identifier to goods which is obtained by referencing the part of the transaction information and which will be sold in the transaction;
(d) passing the goods, via a retail store or directly, to a delivery service provider;
(e) searching for, by the delivery service provider, a retail store specified by a buyer and delivering the goods to the retail store;
(f) sending a notification to said buyer s terminal in response to the second identifier entered from a terminal at the retail store, the second identifier being attached to the goods;
(g) checking to see if there is a correspondence between the first identifier recorded on a recording medium taken by a buyer and the second identifier attached to the delivered goods;
(h) passing the delivered goods to the buyer if there is the correspondence; and
(i) transferring an amount for the delivered goods from a buyer's account to a vendor's account.

7. A transaction method comprising the steps of:
(a) assigning a first identifier to transaction information sent from a buyer's terminal, the transaction information relating to a transaction;
(b) sending the first identifier to said buyer's terminal and sending a second identifier associated with the first identifier and a part of the transaction information to a vendor's terminal;
(c) attaching, by a vendor, the second identifier to goods which is obtained by referencing the part of the transaction information and which will be sold in the transaction;
(d) passing the goods, via a retail store or directly, to a delivery service provider;
(e) searching for, by the delivery service provider, a buyer and delivering the goods to a buyer; and
(f) checking to see if there is a correspondence between the first identifier held by the buyer and the second identifier attached to the delivered goods and, if there is the correspondence, passing the delivered goods to the buyer, and giving an instruction, via a portable terminal, to transfer an amount for the delivered goods from a delivery service provider's account to a vendor's account.

8. A transaction method comprising the steps of:
(a) assigning a first identifier to transaction information sent from a buyer's terminal, the transaction information relating to a transaction;
(b) sending the first identifier to said buyer's
(c) sending a second identifier associated with the first identifier and a part of the transaction information to a vendor's terminal;
(d) sending a notification to said buyer's terminal in response to an instruction indicating that goods, to which the second identifier is attached, have been delivered to a retail store, the goods being obtained by referencing the part of the transaction information and being sold in the transaction;
(e) accepting the first identifier received by a buyer and the second identifier attached to the delivered goods and checking to see if there is a correspondence between the first and second identifiers; and
(f) outputting an instruction allowing the delivered goods to be passed to the buyer if there is the correspondence.

9. A transaction apparatus comprising:
(a) means for assigning a first identifier to transaction information sent from a buyer's terminal, the transaction information relating to a transaction;
(b) means for sending the first identifier to said buyer's terminal;
(c) means for sending a second identifier associated with the first identifier and a part of the transaction information to a vendor's terminal;
(d) means for sending a notification to said buyer's terminal in response to an instruction indicating that goods, to which the second identifier is attached, have been delivered to a retail store, the goods being obtained by referencing the part of the transaction information and being sold in the transaction;
(e) means for accepting the first identifier received by a buyer and the second identifier attached to the delivered goods and checking to see if there is a correspondence between the first and second identifiers; and
(f) means for outputting an instruction allowing the delivered goods to be passed to the buyer if there is the correspondence.

10. A transaction method comprising the steps of:
(a) assigning a first identifier to transaction information sent from a buyer's terminal, the transaction information relating to a transaction;
(b) sending the first identifier to said buyer's terminal;
(c) sending a second identifier associated with the first identifier and a part of the transaction information to a vendor's terminal;
(d) attaching, by a vendor, the second identifier to goods which is obtained by referencing the part of the transaction information and which will be sold in the transaction;
(e) passing the goods, via a retail store or directly, to a delivery service provider;
(f) searching for, by the delivery service provider, a retail store specified by a buyer and delivering the goods to the retail store;
(g) sending a notification to said buyer's terminal in response to the second identifier entered from a terminal at the retail store, the second identifier being attached to the goods;
(h) checking to see if there is a correspondence between the first identifier recorded on a recording medium taken by a buyer and the second identifier attached to the delivered goods; and
(i) passing the delivered goods to the buyer if there is the correspondence.

11. A transaction method comprising the steps of:
(a) assigning a first identifier to transaction information sent from a buyer's terminal, the transaction information relating to a transaction;
(b) sending the first identifier to said buyer's terminal;
(c) sending a second identifier associated with the first identifier and a part of the transaction information to a vendor's terminal;
(d) attaching, by a vendor, the second identifier to goods which is obtained by referencing the part of the transaction information and which will be sold in the transaction;
(e) passing the goods, via a retail store or directly, to a delivery service provider; and
(f) searching for, by the delivery service provider, a buyer and delivering the goods to the buyer.

12. The transaction method as defined by claim 1, further comprising the steps of:
(i) receiving the first identifier, a name of goods to be returned, and a reason for returning the goods from the buyer's terminal to send the name of the goods to be returned and the reason for returning the goods to the vendor's terminal when the buyer requests to return the goods during a cooling-off period after the transaction is completed and before the buyer pays for the goods;
(k) extending the cooling-off period;
(l) sending a notification to the vendor's terminal in response to an instruction indicating that the goods to be returned has been delivered to a vendor-specified retail store, the first identifier being attached by the buyer to the goods to be returned;
(m) accepting the second identifier received by the vendor and the first identifier attached to the goods to be returned to check to see if there is a correspondence between the identifiers; and
(n) outputting an instruction allowing the delivered goods, which will be returned, to be passed to the vendor if there is the correspondence.

13. The transaction method as defined by claim 6, further comprising the steps of:
(j) receiving the first identifier, a name of goods to be returned, and a reason for returning the goods from the buyer's terminal to send the name of the goods to be returned and the reason for returning the goods to the vendor's terminal when the buyer requests to return the goods during a cooling-off period after the transaction is completed and before the buyer pays for the goods;
(k) extending the cooling-off period;
(l) sending a notification to the vendor's terminal in response to an instruction indicating that the goods to be returned has been delivered to a vendor-specified retail store, the first identifier being attached by the buyer to the goods to be returned;
(m) accepting the second identifier received by the vendor and the first identifier attached to the goods to be returned to check to see if there is a correspondence between the identifiers; and
(n) outputting an instruction allowing the delivered goods, which will be returned, to be passed to the vendor if there is the correspondence.

14. The transaction method as defined by claim 10, further comprising the steps of:
(j) receiving the first identifier, a name of goods to be returned, and a reason for returning the goods from the buyer's terminal to send the name of the goods to be returned and the reason for returning the goods to the vendor's terminal when the buyer requests to return the goods during a cooling-off period after the transaction is completed and before the buyer pays for the goods;
(k) extending the cooling-off period;
(l) sending a notification to the vendor's terminal in response to an instruction indicating that the goods to be returned has been delivered to a vendor-specified retail store, the first identifier being attached by the buyer to the goods to be returned;
(m) accepting the second identifier received by the vendor and the first identifier attached to the goods to be returned to check to see if there is a correspondence between the identifiers; and
(n) outputting an instruction allowing the delivered goods, which will be returned, to be passed to the vendor if there is the correspondence.

15. The transaction method as defined by claim 1, further comprising the step of:
preventing the information from being searched for using the first identifier or the second identifier when the transaction is completed.

16. The transaction method as defined by claim 8,
wherein said step of sending the first identifier to the buyer's terminal comprises also sending an instruction to pay the amount for the goods into the predetermined account, and
wherein said step of sending the second identifier and the part of the transaction information to the vendor's terminal receives a payment completion notification from a banking terminal at a predetermined bank in which the amount for the goods has been paid into the predetermined account under a name of the first identifier to send the payment completion notification, the second identifier, and the part of the transaction information to the vendor's terminal.

17. The transaction method as defined by claim 10,
wherein said step of sending the first identifier to the buyer's terminal comprises also sending an instruction to pay the amount for the goods into the predetermined account, and
wherein said step of sending the second identifier and the part of the transaction information to the vendor's terminal receives a payment completion notification from a banking terminal at a predetermined bank in which the amount for the goods has been paid into the predetermined account under a name of the first identifier to send the payment completion notification, the second identifier, and the part of the transaction information to the vendor's terminal.

18. The transaction method as defined by claim 1, wherein the first identifier received by the buyer or the second identifier received by the vendor is a printed identifier of the identifier or the second identifier displayed on the buyer's terminal or the vendor's terminal.

19. The transaction method as defined by claim 1, wherein the first identifier and/or the second identifier is a bar code.

20. The transaction apparatus as defined by claim 3, further comprising:
(j) means for receiving the first identifier, a name of goods to be returned, and a reason for returning the goods from the buyer's terminal to send the name of the goods to be returned and the reason for returning the goods to the vendor's terminal when the buyer requests to return the goods during a cooling-off period after the transaction is completed and before the buyer pays for the goods;
(k) means for extending the cooling-off period;
(l) means for sending a notification to the vendor's terminal in response to an instruction indicating that the goods to be returned has been delivered to a vendor-specified retail store, the first identifier being attached by the buyer to the goods to be returned;
(m) means for accepting the second identifier received by the vendor and the first identifier attached to the goods to be returned to check to see if there is a correspondence between the identifiers; and
(n) means for outputting an instruction allowing the delivered goods, which will be returned, to be passed to the vendor if there is the correspondence.

21. The transaction apparatus as defined by claim 9, further comprising:
(j) means for receiving the first identifier, a name of goods to be returned, and a reason for returning the goods from the buyer's terminal to send the name of the goods to be returned and the reason for returning the goods to the vendor's terminal when the buyer requests to return the goods during a cooling-off period after the transaction is completed and before the buyer pays for the goods;
(k) means for extending the cooling-off period;
(l) means for sending a notification to the vendor's terminal in response to an instruction indicating that the goods to be returned has been delivered to a vendor-specified retail store, the first identifier being attached by the buyer to the goods to be returned;
(m) means for accepting the second identifier received by the vendor and the first identifier attached to the goods to be returned to check to see if there is a correspondence between the identifiers; and
(n) means for outputting an instruction allowing the delivered goods, which will be returned, to be passed to the vendor if there is the correspondence.

22. The transaction apparatus as defined by claim 3, further comprising:
(o) means for preventing the information from being searched for using the first identifier or the second identifier when the transaction is completed.

23. The transaction apparatus as defined by claim 9,
wherein said means for sending the first identifier to the buyer's terminal also sends an instruction to pay the amount for the goods into the predetermined account, and
wherein said means for sending the second identifier and the part of the transaction information to the vendor's terminal receives a payment completion notification from a banking terminal at a predetermined bank in which the amount for the goods has been paid into the predetermined account under a name of the first identifier to send the payment completion notification, the second identifier, and the part of the transaction information to the vendor's terminal.

24. The transaction apparatus as defined by claim 3, wherein the first identifier received by the buyer or the second identifier received by the vendor is a printed identifier of the first identifier or the second identifier displayed on the buyer's terminal or the vendor's terminal.

25. The transaction apparatus as defined by claim 3, wherein the first identifier and/or the second identifier is a bar code.

26. A transaction program for use on a transaction apparatus, wherein the program causes a computer to execute the following steps comprising:
(a) assigning a first identifier to transaction information sent from a buyer's terminal, the transaction information relating to a transaction;
(b) sending the first identifier to said buyer's terminal and sending a second identifier associated with the first identifier and a part of the transaction information to a vendor's terminal;
(c) sending a notification to said buyer's terminal in response to an instruction indicating that goods, to which the second identifier is attached, have been delivered to a retail store, the goods being obtained by referencing the part of the transaction information and being sold in the transaction;
(d) checking to see if there is a correspondence between the identifiers upon receiving the first identifier received by a buyer and the second identifier attached to the delivered goods;
(e) outputting an instruction allowing the delivered goods to be passed to the buyer if there is the correspondence; and
(f) sending an instruction requesting to transfer an amount for the goods from a buyer's account to a predetermined account.

27. The transaction program as defined by claim 26 wherein said step of sending an instruction requesting to transfer an amount for the goods to a vendor's account sends an instruction to request to transfer the amount for the goods from an account of a retail store specified by the buyer to the vendor's account.

28. The transaction program as defined by claim 26 wherein said step of sending an instruction requesting to transfer the amount for the goods to a vendor's account comprising:
sending an instruction to request to transfer the amount for the goods from an account of a delivery service provider to the vendor's account, the delivery service provider delivering the goods.

29. A transaction program for use on a transaction apparatus, wherein the program causes a computer to execute the following steps comprising:
(a) assigning a first identifier to transaction information sent from a buyer's terminal, the transaction information relating to a transaction;
(b) sending the first identifier to said buyer's terminal;
(c) sending a second identifier associated with the identifier and a part of the transaction information to a vendor's terminal;
(d) sending a notification to said buyer's terminal in response to an instruction indicating that goods, to which the second identifier is attached, have been delivered to a retail store, the goods being obtained by referencing the part of the transaction information and being sold in the transaction;
(e) accepting the first identifier received by a buyer and the second identifier attached to the delivered goods to check to see if there is a correspondence between the identifiers; and
(f) outputting an instruction allowing the delivered goods to be passed to the buyer if there is the correspondence.

30. The transaction program as defined by claim 26, wherein the program further comprises the steps of:
(g) receiving the identifier, a name of goods to be returned, and a reason for returning the goods from the buyer's terminal to send the name of the goods to be returned and the reason for returning the goods to the vendor's terminal when the buyer requests to return the goods during a cooling-off period after the transaction is completed and before the buyer pays for the goods;
(h) extending the cooling-off period;
(i) sending a notification to the vendor's terminal in response to an instruction indicating that the goods to be returned has been delivered to a vendor-specified retail store, the first identifier being attached by the buyer to the goods to be returned;
(j) accepting the second identifier received by the vendor and the first identifier attached to the goods to be returned to check to see if there is a correspondence between the identifiers; and
(k) outputting an instruction allowing the delivered goods, which will be returned, to be passed to the vendor if there is the correspondence.

31. The transaction program as defined by claim 26, wherein the program further comprises the steps of:
preventing the information from being searched for using the first identifier or the second identifier when the transaction is completed.

32. The transaction program as defined by claim 29,
wherein said step of sending the first identifier to the buyer's terminal comprising also sending an instruction to pay the amount for the goods into the predetermined account, and
wherein said step of sending the second identifier and the part of the transaction information to the vendor's terminal comprises receiving a payment completion notification from a banking terminal at a predetermined bank in which the amount for the goods has been paid into the predetermined account under a name of the first identifier to send the payment completion notification, the second identifier, and the part of the transaction information to the vendor's terminal.

33. The transaction program as defined by one of claim 26, wherein the first identifier received by the buyer or the second identifier received by the vendor is a printed identifier of the first identifier or the second identifier displayed on the buyer's terminal or the vendor's terminal.

34. The transaction program as defined by claim 26, wherein the first identifier received by the buyer and/or the second identifier received by the vendor is a bar code.
